(19) United States
(12) Patent Application Publication
(10) Pub. No.: US 2010/0066686 A1
(43) Pub. Date: Mar. 18, 2010

(54) MULTIPOINT TOUCH SENSOR WITH ACTIVE MATRIX

(75) Inventors: Pascal Joguet, Sadirac (FR); Julien Olivier, Bordeaux (FR)

Correspondence Address: ARENT FOX LLP, 1050 CONNECTICUT AVENUE, N.W., SUITE 400, WASHINGTON, DC, 20036, US

(73) Assignee: Stantum, Bordeaux (FR)

(21) Appl. No.: 12/306,802

(22) PCT Filed: Jun. 28, 2007
(86) PCT No.: PCT/FR2007/001096

§ 371 Date: Mar. 31, 2009

(30) Foreign Application Priority Data
Jun. 28, 2006 (FR) 0605828

(51) Int. Cl. G06F 3/041

(52) U.S. Cl. 345/173

(57) ABSTRACT

The present invention relates to a multipoint touch sensor with active matrix comprising: —a matrix layer exhibiting N×M independent cells, each of the cells P_{x, y} being linked to a row Lₓ and to a column C_{y} through a switching element, the rows Lₓ being common to all the cells P_{x, i}, i lying between 1 and N, and the columns C_{y} being common to all the cells P_{j, y}, j lying between 1 and Q, Q being at most equal to M, an intermediate layer able to cause a local modification of the electrical properties of the cells situated under the tactile activation zone, said intermediate layer being placed between the active surface of the adjacent surface of the said P_{x, y}, cells, —an upper activation layer allowing tactile interaction, —an electronic circuit sequentially controlling, for each set of cells C_{a, b1-b2} with b2-b1 lying between 1 and Q, a first step of activating said cells C_{a, b1-b2} followed by a second step of detecting the electrical properties of each cell C_{a, b1-b2} individually so as to deliver an item of information representative of the zones activated by touch.

The present invention concerns the field of multipoint touch sensors for controlling equipment, preferably by means of a graphical interface, the sensor being provided with means of acquiring simultaneously the position, the pressure, the size, the shape and the movement of several fingers on its surface.

Multipoint touch sensors are known in the prior art. By way of example, the patent WO2005/091104 describes a device for controlling computerised equipment comprising a multicontact bidimensional sensor for acquiring touch information, characterised in that it also comprises a display screen disposed under the bidimensional touch sensor as well as a memory for recording graphical objects each associated with at least one processing law, and a local computer for analysing the position of the touch information acquired and applying a processing law according to the said position with respect to the position of the graphical objects.

The sensors of the prior art have the drawback of an erroneous response in the case where three contacts are aligned along two orthonormal axes. In this case, is not possible to detect the presence or disappearance of an additional contact. The first three contacts mask the detection of additional contacts.

To meet this drawback, the invention concerns, in its most general sense, an active-matrix multipoint touch sensor comprising:
a matrix layer having N×M independent cells, each of the cells P_{x,y} being connected to a row Lₓ and to a column C_{y} through a switching element, the rows Lₓ being common to all the cells P_{x,i}, i being between 1 and N, and the columns C_{y} being common to all the cells P_{j,y}, j being between 1 and Q, Q being no more than M,
an intermediate layer able to cause a local modification of the electrical properties of the cells situated under the touch activation zone, the said intermediate layer being placed between the active surface and the adjacent surface of the said cells P_{x,y}
a top activation layer affording touch interaction
an electronic circuit sequentially controlling, for each set of cells C_{a, b1-b2} with b2-b2 being between 1 and Q, a first step of activation of the said cells C_{a, b1-b2} and then a second step of detecting the electrical properties of each cell C_{a, b1-b2} individually in order to deliver information representing the areas activated tactilely.

The independence of each of the cells makes it possible to avoid the drawback of the sensors of the prior art, avoiding the masking phenomenon when three contacts are positioned orthogonally.

According to a preferred variant, each of the layers is transparent. This variant makes it possible to display graphical information through the sensor, in particular information whose configuration is controlled by the actions detected by the sensor positioned on this screen.

Preferably, the sensor also comprises an additional display layer common to all the cells. Alternatively, each of the cells P_{x,y} also comprises display means.

Advantageously, the said display means are activated by the signal generated during the said first activation step. This variant makes it possible to produce interactive sensors proceeding with the display of information varying synchronously with the actions performed on the external surface. These designs constitute multipoint touch screens.

According to another variant, the circuit comprises a means of controlling the said signal generated during the said first activation step according to the display parameters sought, and means of controlling the detection during the said second step, according to the signal applied to the said cell during the first step. This variant makes it possible to control alternatively the display and detection of the signal.

According to a first embodiment, the intermediate layer is divided into separate elements each corresponding to at least one cell.

According to a second embodiment, the intermediate layer is formed by a single zone.

According to a first embodiment, the intermediate layer comprises a piezoelectric material.

Advantageously, such a sensor is formed by a dielectric substrate on which there are deposited electrodes distributed so as to form an active matrix of cells, this matrix layer being covered by an intermediate detection layer formed by a sheet of piezoelectric material, this sheet being covered by a sheet of uniform transparent conductor.

Alternatively, it is formed by a dielectric substrate on which there are deposited electrodes each coated with a piezoelectric material, this matrix layer being covered by a sheet of uniform transparent conductor.

According to a second embodiment, the sensor according to the invention comprises means of activating the piezoelectric material by electrical signals applied to the said electrodes.

According to a third embodiment, the intermediate layer comprises a dielectric material, the detection being performed by an impedance measurement.

Advantageously, such a sensor is formed by a dielectric substrate on which there are deposited electrodes distributed so as to form an active matrix of cells, this matrix layer being covered by an intermediate detection layer formed by a sheet of material whose resistivity is a function of the deformation in a direction perpendicular to the surface of the sensor, this sheet being covered by a sheet of uniform transparent conductor.

According to a variant, it is formed by a dielectric substrate on which there are deposited electrodes each coated with a material whose resistivity is a function of the deformation in a direction perpendicular to the surface of the sensor, this matrix layer being covered by a sheet of uniform transparent conductor.

According to a particular embodiment, the sensor is formed by a dielectric substrate on which there are deposited electrodes distributed so as to form an active matrix of cells, this matrix layer being covered by an insulating layer.

According to a variant, the said switching element is a bidirectional element. This solution makes it possible to modify the behaviour of the intermediate layer and to measure the variations in its behaviour.

Advantageously, the sensor is formed by a dielectric substrate on which there are deposited electrodes forming a matrix coated with a layer of liquid crystal, this layer being covered by a sheet of uniform transparent conductor.

According to another embodiment, the sensor is formed by a dielectric substrate on which there are deposited electrodes forming an active matrix coated with a layer of liquid crystal, this layer being covered by a sheet of uniform transparent conductor.

According to another embodiment, the said switching element is a MOSFET transistor.

The invention will be better understood from a reading of the following description referring to the accompanying drawings corresponding to non-limitative embodiments where:

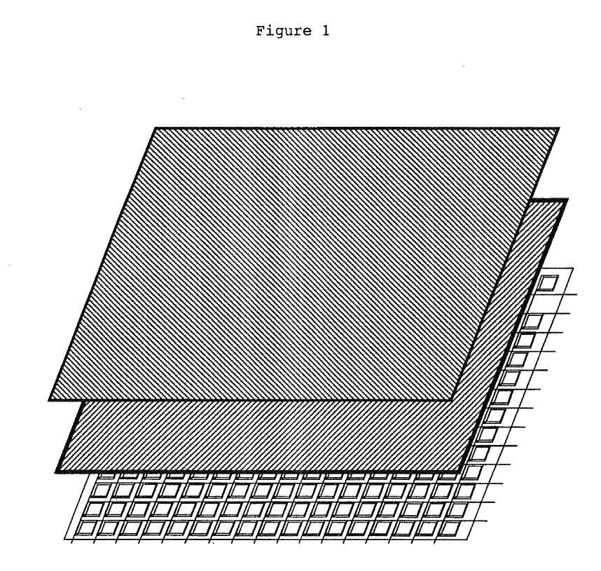

FIG. 1 depicts an exploded view of a sensor according to an embodiment where the intermediate layer is uniform,

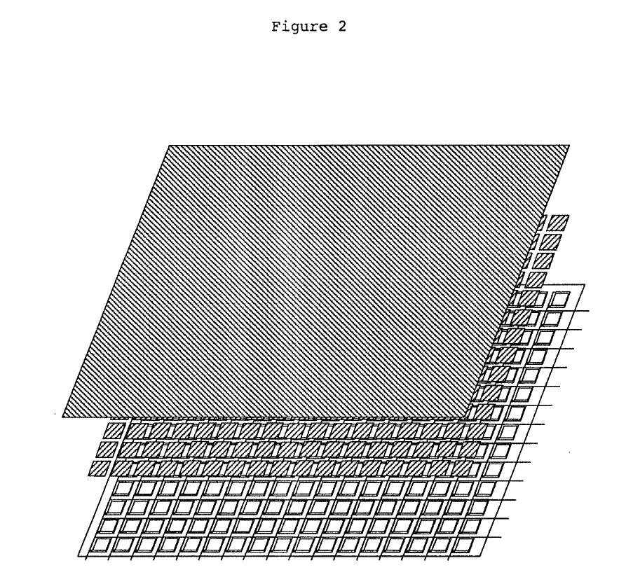

FIG. 2 depicts an exploded view of a sensor according to an embodiment where the intermediate layer is divided into isolated zones,

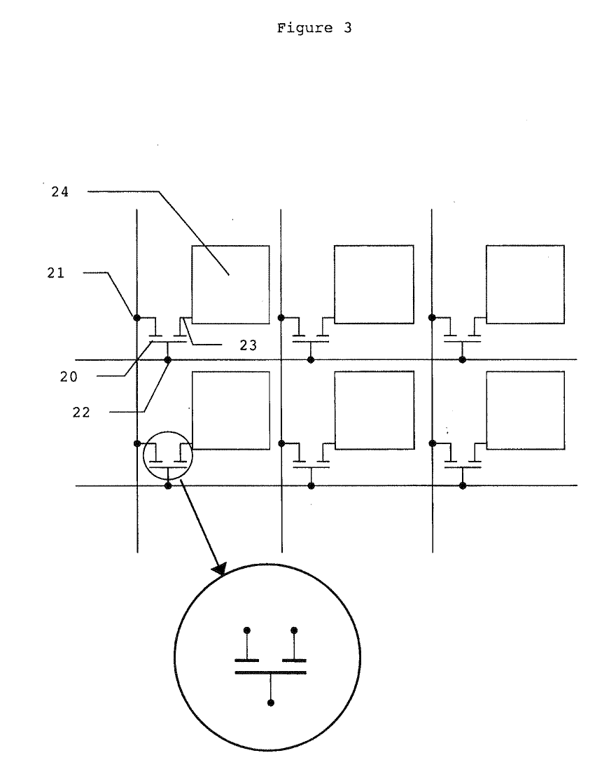

FIG. 3 depicts a detailed view of a set of cells of a first embodiment,

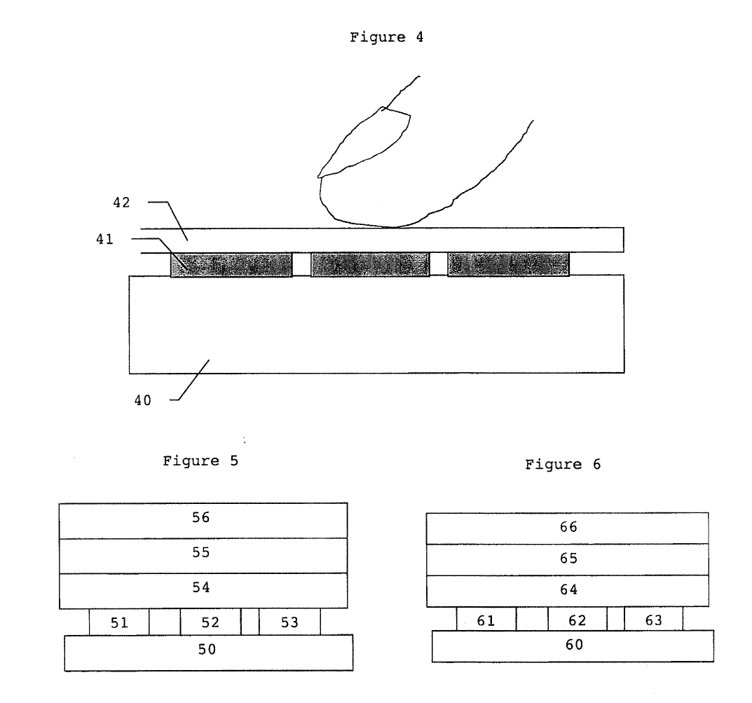

FIG. 4 depicts a detailed view of a set of cells of a second embodiment,

FIG. 5 depicts a detailed view of a set of cells of a third embodiment,

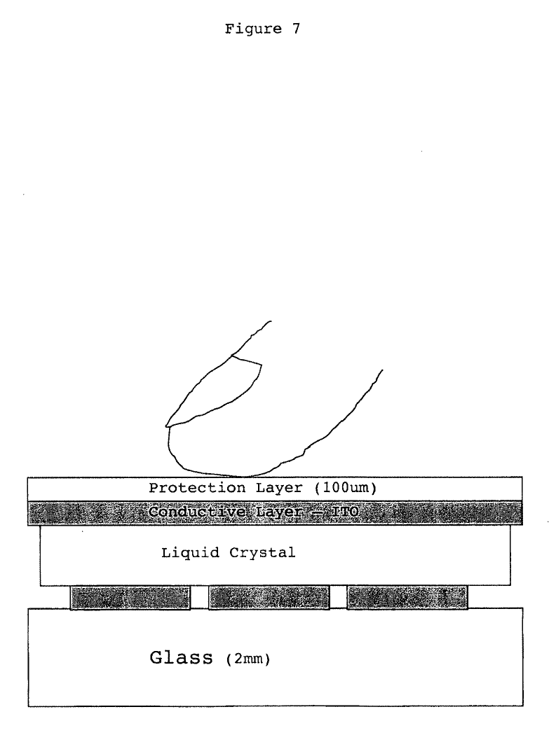

FIG. 6 depicts a detailed view of a set of cells of a fourth embodiment,

FIG. 7 depicts a detailed view of a set of cells of a fifth embodiment,

FIG. 1 depicts an exploded view of sensor according to an embodiment where the intermediate layer is uniform.

FIG. 2 depicts an exploded view of a sensor according to an embodiment where the intermediate layer is divided into isolated zones.

FIG. 3 depicts a detailed view of a set of cells of a first embodiment.

In this example embodiment, the multicontact touch screen is formed by a TFT active matrix having N×M independent cells, each cell Ci being addressed independently by two signals.

Active matrixing makes it possible to address independently a matrix composed of X identical cells. The matrixing is effected by means of two signals per cell. The signals are common for the cells aligned on the same column or on the same row. In this way, the number of signals to make transit (2 minima per cell) in order to control N×M cells is only N+M instead of N×M×2. The use of a transistor at the terminals of each cell makes it possible to address a cell independently.

Each cell comprises a MOSFET transistor (20) with three electrodes (21 to 23): a gate (22), a drain (23) and a source (21). The transistor is conductive when the gate/source voltage (Vgs) is above a threshold (Vth). The drain (23) is connected to the can (24). The gate is connected to the row and the source (21) to the column.

FIG. 4 depicts a view in section of a capacitive sensor using the construction of a TFT liquid crystal screen.

This sensor comprises:
a substrate (40), for example a sheet of glass with a thickness of two millimetres,
a metallised TFT matrix on a bottom layer comprising transparent conduction cells forming electrodes (41) produced from a material such as ITO, conductive polymers, or other transparent conductive material, with a surface area of 10 mm² for example,
a thin (100 μm) transparent dielectric top layer (42) with high relative permittivity (for example PVC: 5) and protecting the bottom layer from external attacks. This layer (42) is transparent.

The activation system (for example a finger) creates a closed electrical circuit with one of the reference voltages of the measuring system (for example earth) when it is situated close to the cell (it then behaves as an electrode).

By virtue of the active matrix addressing, it is possible to make a capacitive measurement on each cell independently.

With the above mentioned dimensions, the capacitance created by the presence of a finger close to the top layer is around 4 pF.

FIG. 5 depicts a pressure-sensitive sensor based on a transparent piezoelectric material.

This sensor comprises:
a substrate (50) formed by a sheet of glass with a thickness of two millimetres,
a metallised TFT matrix on a bottom layer (50) comprising transparent conductive cells (51 to 53),
an intermediate layer (54) of transparent piezoelectric material (eg: piezoelectric polymer, piezoelectric ceramic, etc), uniform or forming cells independent of one another and covering the bottom electrodes,
a conductive top layer (55) forming a metallised transparent substrate on a protective film (56).

A pressure exerted on the top layer creates a difference in potential between the two faces of the piezoelectric material. The substrate unifying the voltage for its part, the TFT matrix makes it possible to measure the voltages independently at each point where an electrode is situated. If the piezoelectric material is deposited as independent cells, the effects due to the mechanical force (pressure) will be localised and will not create a mechanical/piezoelectric interdependence.

The piezoelectric layer is, in the example described, common to all the cells. Alternatively, the sensor comprises a piezoelectric layer forming independent cells corresponding to the TFT cells.

FIG. 6 depicts a detailed view in section of a set of cells of a fourth embodiment. This variant is a pressure-sensitive sensor based on a transparent conductive material whose resistivity changes under the effect of a deformation (due to a mechanical pressure).

This sensor comprises:
a substrate (60) formed by a sheet of glass with a thickness of two millimetres,
a metallised TFT matrix on a bottom layer comprising transparent conductive cells (61 to 63),
an intermediate layer of transparent conductive material (64), for example a conductive polymer, uniform or forming cells independent of one another and covering the bottom electrodes,
a conductive top layer (65) forming a metallised transparent substrate on a protective film (66).

A pressure exerted on the top layer creates a variation in resistivity between the two faces of the aforementioned conductive material. The substrate unifying the electrical potential for its part, the TFT matrix makes it possible to measure the resistance independently at each point where an electrode is situated.

Implementation can be effected in two ways:
an intermediate layer of transparent conductive material common to all the cells,
an intermediate layer of transparent conductive material forming independent cells corresponding to the TFT cells.

FIG. 7 depicts a detailed view in section of a set of cells of a fifth sensor embodiment using the integral construction of a standard TFT LCD screen.

When a pressure is exerted on the top layer of an LCD, optical changes result in the pressure zone, and modifications to electrical properties of the liquid crystal in this same zone. When the control voltage is established on the pixels, the electrical characteristics (R, C, charging time, etc) are measured and are compared with the characteristics measured in the idle state (without exerted pressure).

For these various embodiments, the sensor is connected to an electronic control circuit comprising N+M connections. The electrical circuit delivers a time sweep signal sequentially activating the N×M cells and detecting the variations in the signal produced by the passage of the activated cell. The information is recorded in a temporary memory in order to form an image of the sensor, for each sweep cycle.

1. An active-matrix simultaneous-acquisition multipoint touch sensor comprising:
a matrix layer having N×M independent cells, each of the cells Px, y (24) being connected to a row Lx and to a column Cy through a switching element, the rows Lx being common to all the cells Px, i, i being between 1 and N, and the columns C_{y} being common to all the cells Pj, y, j being between 1 and Q, Q being no more than M,
an intermediate layer able to cause a local modification of the electrical properties of the cells situated under the touch activation zone, the intermediate layer being placed between the active surface and the adjacent surface of the said cells Px, y,
a top activation layer affording touch interaction,
an electronic circuit sequentially controlling, for each set of at least one cell C_{a,b} being between 1 and Q, a first step of activation of the cells C_{a,b,} and then a. second step of detecting the electrical properties of each cell Cₐ, b, individually in order to deliver multiple touch information representing the areas activated tactilely simultaneously.

2. A touch sensor according to claim 1, characterised in that each of the layers is transparent.

3. A sensor according to claim 2 which, also comprises an additional display layer.

4. A touch sensor according to claim 2, characterised. in that each of the cells Px, y also comprises display means.

5. A touch sensor according to claim 4, characterised in that the display means are activated by the signal generated during the first activation step.

6. A touch sensor according to claim 5, characterised in that the circuit comprises a means of controlling the signal generated during the first activation step according to the active matrix addressing, and a means of controlling the detection during the second step, depending on the signal applied to the cell during the first step.

7. A touch sensor according to claim 1, characterised in that the intermediate layer is divided into separate elements, each corresponding to at least one cell.

8. A touch sensor according to accordingly to claim 1, characterised in that the intermediate layer is formed by a single zone.

9. A touch sensor according to claim 1, characterised in that the intermediate layer comprises a piezoelectric material.

10. A touch sensor according to claim 9, formed by a dielectric substrate on which there are deposited electrodes distributed so as to form an active matrix of cells, said matrix layer being covered by a said intermediate layer which includes a intermediate detection layer formed by a sheet of piezoelectric material, this sheet being covered by a sheet of uniform transparent conductor.

11. A touch sensor according to claim 9, formed by a dielectric substrate on which there are deposited electrodes each coated with a piezoelectric material, this matrix layer being covered by a sheet of uniform transparent conductor.

12. A touch sensor according to claim 9, characterised in that it comprises means of activating the piezoelectric material by a pressure exerted on the top layer, creating a difference in potential between the two faces of the piezoelectric material making it possible to measure electrical signals created by this pressure and applied to the electrodes.

13. A touch sensor according to claim 1, characterised in that the intermediate layer comprises a dielectric material, the detection being performed by an impedance measurement.

14. A touch sensor according to claim 13, formed by a dielectric substrate on which there are deposited electrodes distributed so as to form an active matrix of cells, this matrix layer being covered by an intermediate detection layer formed by a sheet of material whose resistivity depends on the deformation in a direction perpendicular to the surface of the sensor, this sheet being covered by a sheet of uniform transparent conductor.

15. A touch sensor according to claim 13, formed by a dielectric substrate on which there are deposited electrodes each coated with a material whose resistivity depends on the deformation in a direction perpendicular to the surface of the sensor, this matrix layer being covered by a sheet of uniform transparent conductor.

16. A touch sensor according to claim 13, formed by a dielectric substrate on which there are deposited electrodes distributed so as to form an active matrix of cells, this matrix layer being covered by an insulating layer.

17. A touch sensor according to claim 1, characterised in that the said switching element is a bidirectional element.

18. A touch sensor according to claim 1, formed by a dielectric substrate on which there are deposited electrodes forming a matrix coated by a liquid crystal layer, this layer being covered by a sheet of uniform transparent conductor.

19. A touch sensor according to claim 1 characterised in that the said switch element is a MOSFET transistor.

20. A touch sensor according to any one of claims 2 to 8, characterised in that the said intermediate layer comprises a piezoelectric material.

21. A touch sensor according to any one of claims 2 to 8, characterised in that the said intermediate layer comprises a dielectric material, the detection being performed by an impedance measurement.
